(19) United States
(12) Patent Application Publication
(10) Pub. No.: US 2025/0288395 A1
(43) Pub. Date: Sep. 18, 2025

(54) FALSE TOOTH IMPLANTING DEVICE HAVING WIDENING EFFECT

(71) Applicant: Zhijun PENG, Foshan (CN)

(72) Inventor: Zhijun PENG, Foshan (CN)

(21) Appl. No.: 18/914,280

(22) Filed: Oct. 14, 2024

(30) Foreign Application Priority Data
Mar. 18, 2024 (CN) 2024103081165

(51) Int. Cl. A61C 8/00

(52) U.S. Cl. CPC A61C 8/0009; A61C 8/0033

(57) ABSTRACT

A false tooth implanting device with widening effect, including a main implant body, a lower block, and a vertical screw which is threaded to the lower block after passing through the main implant body; a small vertical securing screw is threaded to a screw hole provided on the vertical screw; an installation direction indicator is provided on a top surface of the device such that dentist can quickly and conveniently knows a direction which the widening effect will achieve, thus enhancing installation accuracy, avoiding suffering to the alveolar bone due to widening effect towards an incorrect direction, and thereby ensuring safety and convenience of the use of the device and the efficiency of false tooth implantation

### BACKGROUND OF THE INVENTION

The present invention relates to the field of dental implantation, and in particular, to a false tooth implanting device having widening effect.

Nowadays, when it is required to implant a false tooth, it is usually required to cut open the gum at the missing tooth position, and then drill a hole for implant in the alveolar bone beneath the gum, and then screw a false tooth implant having outer screw threads into the hole. After the wound at the gum recovers, a false tooth will be mounted on the implant, and thus achieving the purpose of implanting a false tooth. In the aforesaid method of implanting a false tooth, since the implant is fixed by engaging a screw to the alveolar bone, bone fragments may be easily left in the hole while screwing in the implant into the hole. Bone fragments left in the hole are detached from the lively alveolar bone where they are from, so the bone fragments are dead tissues and may easily decay and thus induce swelling and inflammation. In addition, the existing screw-threaded false tooth implant is fixed by engagement of its outer threads with the alveolar bone surrounding the outer threads. However, due to the varying thickness of on both sides of the alveolar ridge, engagement of the outer threads with the surrounding alveolar bone is likely to cause the two sides of the alveolar ridge to crack, thus resulting in deep injuries that are difficult to heal. This ultimately causes the false tooth to become insecurely fixed and is easy to get loose.

To solve this technical problem, a prior art CN210644209U titled “Integral false tooth implanting device having expansion/widening effect at both upper and lower portions” was filed by the same applicant of the present invention on Jul. 4, 2019 with the China National Intellectual Property Administration under Application No. 201921057515.X. The prior art patent mainly comprises an integral main implant body, a lower protruding block, a vertical screw, and a lateral screw. When the false tooth implanting device is installed in a hole of the alveolar bone, expandable/widening effect is produced to cause the false tooth implanting device to expand/widen and hence to engage firmly against inner surfaces of the hole to achieve fixation. This installation method is not only very secured, but also does not damage the inner surfaces of the hole opened in the alveolar bone; therefore, no bone fragments are resulted, and thus it is less likely to induce inflammation, swelling, or pain which may be otherwise caused by the bone fragments. Such installation method according to this prior art patent can effectively alleviate the pain of patients receiving the implant and prevent the patients from suffering pain and traumatic injuries twice or even more times. Although this prior art patent by the applicant can effectively avoid the secondary or even subsequent pain and traumatic injuries, this prior art patent has the following deficiencies during practical use: Two sides of the alveolar ridge vary in thickness and are usually thin and fragile. In this prior art patent, a direction which the lower protruding block can slide relative to the main implant body in order to achieve a widening effect is fixed. When the lower protruding block is nested into the hole formed in the alveolar bone, it becomes completely hidden and concealed; as a result, the dentist cannot accurately determine whether the lower protruding block will slide towards a direction along the alveolar ridge or slide towards a direction perpendicular to the alveolar ridge, and so the dentist cannot rotate the false tooth implant to a correct direction to result in the widening effect being oriented to a correct direction. Specifically, if the widening effect is oriented to the direction perpendicular to the alveolar ridge, it is a wrong direction, which can easily cause the alveolar bone to crack. If the widening effect is oriented along the alveolar ridge, it is a correct direction. However, given that the lower protruding block is completely hidden and concealed, the prior art patent is significantly deficient in that the dentist is not able to quickly and accurately determine whether the lower protruding block slide towards a correct direction such that the widening effect is achieved in the correction direction to avoid unnecessary injuries to the patients.

Secondly, in this prior art patent, the lateral screw is used at the upper portion of the main implant body to expand and thus press the upper portion of the main implant body firmly against an inner wall of a false tooth to achieve a stable connection between the false tooth and the main implant body. However, an operating space for the lateral screw is very limited due to the side walls of the oral cavity corresponding to the cheeks, and this makes the use of the lateral screw challenging and reduces implantation efficiency. Additionally, it is difficult to align the lateral screw hole on one side of the false tooth with the lateral screw hole on the main implant body, resulting in the difficulty for the lateral screw to pass through both lateral screw holes. This alignment challenge increases the difficulty of installation and affects efficiency. In view of the above-mentioned deficiencies, the applicant believes that this type of false tooth implanting device still needs further improvement to provide patients with a highly economical, efficient, and comfortable false tooth implantation experience.

### BRIEF SUMMARY OF THE INVENTION

In view of the aforementioned problems and deficiencies in the prior art, the present invention provides a false tooth implanting device having widening effect. The false tooth implanting device is provided with an installation direction indicator, enabling a dentist to easily and quickly ascertain a direction which the widening effect will be achieved, thereby significantly improving installation accuracy, preventing trauma to the alveolar bone caused by incorrect direction of the widening effect, and greatly ensuring the safety of this type of dental implant. In addition, the false tooth is directly secured to the main implant body by locking the vertical securing screw vertically through the false tooth into the main implant body, this method provides ample operating space, and the insertion and alignment of the vertical securing screw vertically is very easy, making installation convenient and significantly enhancing the efficiency of installing the false tooth.

The present invention is achieved as follows: A false tooth implanting device with widening effect, comprising a main implant body, a lower block, and a vertical screw; a first inclined surface and a vertical insertion hole is provided on the main implant body; a second inclined surface is provided on the lower block; the first inclined surface and the second inclined surface are slidably engaged with each other; a guide structure is provided between the second inclined surface and the first inclined surface; the vertical screw passes through the vertical insertion hole of the main implant body and threads into the lower block; wherein the false tooth implanting device further comprises a vertical securing screw which is smaller than the vertical screw; a screw hole is further formed vertically in a middle part of the vertical screw; the vertical securing screw is threaded to the screw hole; a top surface of the main implant body is provided with an installation direction indicator to indicate a mutual sliding direction between the main implant body and the lower block and thus a direction of the widening effect being achieved.

Preferably, the guide structure comprises a guiding inclined slot and a guiding inclined protrusion.

Preferably, the top surface of the main implant body is further provided with a storage groove in which an upper end of the locking screw is accommodated; a top surface of the locking screw is flush with the top surface of the main implant body.

Preferably, outer surfaces of the main implant body and the lower block are anti-slippery textured surfaces.

Preferably, the main implant body and the lower block are further provided with a plurality of transverse micropores.

Preferably, a diameter of the lower block is the same as a diameter of the main implant body.

The present invention has the following beneficial effects:

(1) The present invention provides an installation direction indicator on the top surface of the main implant body for indicating the mutual sliding direction between the main implant body 1 and the lower block 2 and thus a direction of the widening effect to be achieved. In this way, even if the lower block is hidden and concealed in the implant hole after being embedded in the alveolar bone after installation, the mutual sliding direction between the main implant body and the lower block can still be quickly observed, thereby quickly and precisely adjusting the false tooth implanting device such that the mutual sliding direction between the main implant body and the lower block aligns with the alveolar ridge. This effectively ensures the accuracy of the installation direction, controlling the widening effect to be achieved in a direction along the alveolar ridge, rather than in a direction perpendicular to the alveolar ridge, thus avoiding secondary traumatic suffering to the patient's alveolar bone. This greatly guarantees the stability and safety of the dental implant, providing the patient with a highly economical, efficient, and comfortable dental implantation experience while saving the patient's time and money.

(2) A screw hole is further formed vertically in a middle part of the vertical screw, and the vertical securing screw is threaded into the screw hole. In this way, the false tooth is directly secured to the main implant body by locking the vertical securing screw vertically through the false tooth into the main implant body. Such structural design not only provides ample operating space but also makes it easy to observe the position of the screw hole, so that insertion and alignment of the vertical securing screw with the screw hole is easy, making installation convenient and significantly enhancing the efficiency of installing the false tooth. Further, the locking of the vertical securing screw ensures that the false tooth is firmly, reliably, and safely secured on the main implant body and will not easy get loose.

(3) The main implant body and the lower block of the false tooth implanting device have a same diameter without any protrusions thereon, so that during implantation, an implantation depth of the false tooth implanting device and a mounting depth of the false tooth crown can be adjusted according to an actual condition of the alveolar bone. This greatly facilitates and meets the practical operational requirements of dentists.

### BRIEF DESCRIPTION OF THE DRAWINGS

FIG. 1 is a schematic diagram illustrating the perspective view of a false tooth implanting device according to the present invention.

FIG. 2 is a schematic diagram illustrating an exploded view of the false tooth implanting device according to the present invention.

FIG. 3 is a schematic diagram illustrating the installation structure of the false tooth implanting device and a false tooth according to the present invention.

FIG. 4 is a schematic diagram illustrating a use state of the false tooth implanting device installed on the alveolar bone according to the present invention.

### DETAILED DESCRIPTION OF THE INVENTION

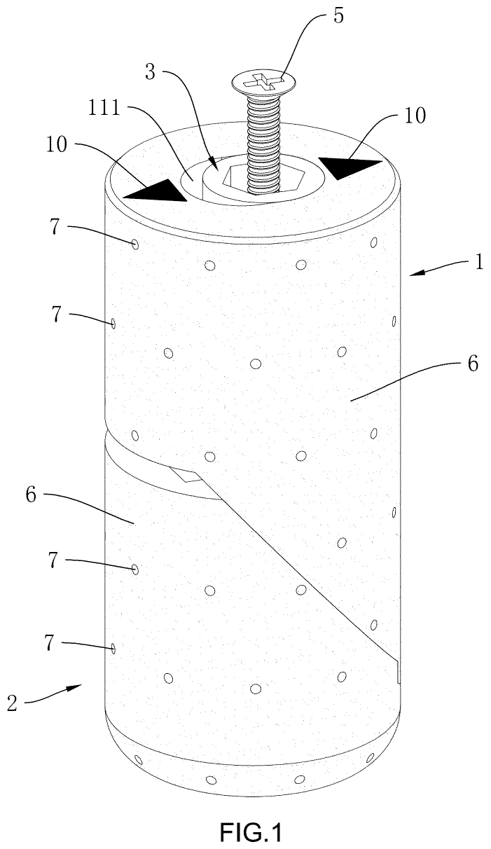

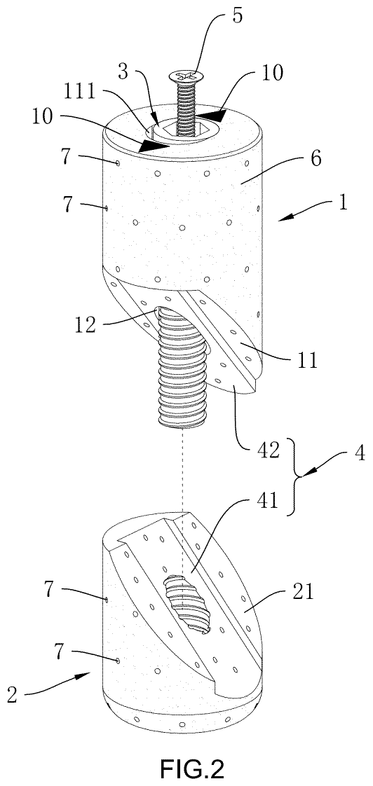

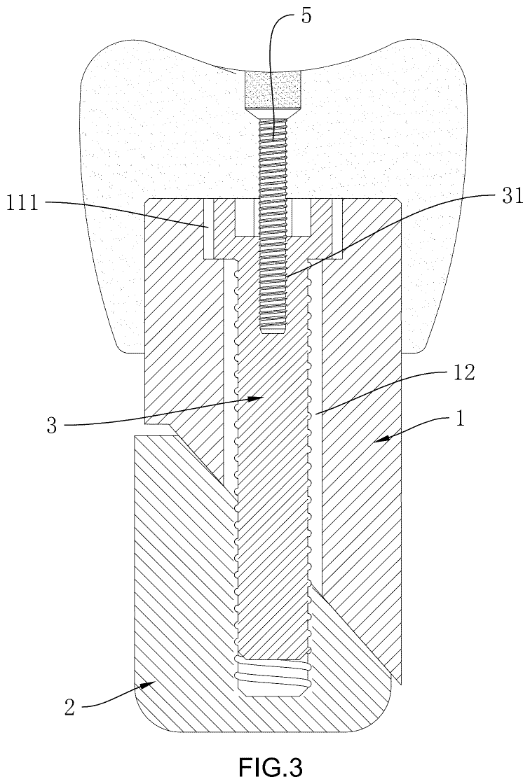

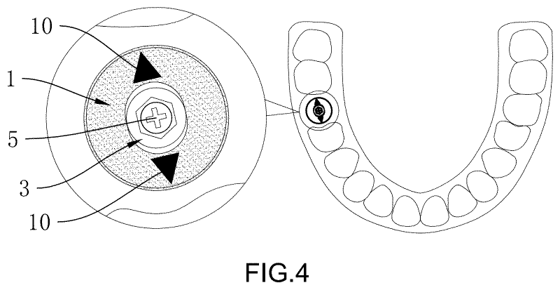

As shown in FIGS. 1 and 2, the present invention relates to a false tooth implanting device with widening effect, comprising a main implant body 1, a lower block 2, and a vertical screw 3; wherein a first inclined surface 11 and a vertical insertion hole 12 is provided on the main implant body 1; a second inclined surface 21 is provided on the lower block 2; the first inclined surface 11 and the second inclined surface 21 are slidably engaged with each other such that when the main implant body 1 and the lower block 2 slide with respect to each other through the first inclined surface 11 and the second inclined surface 21, the main implant body 1 and the lower block 2 achieves a widening effect of the false tooth implanting device as shown in FIG. 3; a guide structure 4 is provided between the second inclined surface 21 and the first inclined surface 11; the vertical screw 3 passes through the vertical insertion hole 12 of the main implant body 1 and threads into the lower block 2. To achieve the purpose of the present invention, the present invention further comprises a vertical securing screw 5 which is smaller than the vertical screw 3. A screw hole 31 is further formed vertically in a middle part of the vertical screw 3; the vertical securing screw 5 is threaded to the screw hole 31; a top surface of the main implant body 1 is provided with an installation direction indicator 10 to indicate a mutual sliding direction between the main implant body 1 and the lower block 2 and thus a direction of the widening effect to be achieved. As shown in FIG. 4, the installation direction indicator 10 is provided to allow quick observation of the mutual sliding direction between the main implant body 1 and the lower block 2, thereby enabling a rapid and precise adjustment of the false tooth implanting device such that the mutual sliding direction between the main implant body 1 and the lower block 2 align with the alveolar ridge. This significantly improves the accuracy of installation and prevents secondary or multiple traumatic injuries and pain for the patients. In addition, the false tooth is directly secured to the main implant body 1 by locking the vertical securing screw 5 vertically through the false tooth into the main implant body 1, this method provides ample operating space, and the insertion and alignment of the vertical securing screw 5 vertically is very easy, making installation convenient and significantly enhancing the efficiency of installing the false tooth. In practical application, the installation direction indicator 10 can be engraved on the top surface of the main implant body 1 using laser processing technology.

As shown in FIG. 2, to ensure that the lower block 2 does not shift or displace when it is threaded by the vertical screw and slide with respect to the main implant body when the vertical screw rotates, the guide structure 4 comprises a guiding inclined slot 41 and a guiding inclined protrusion 42, with the guiding inclined protrusion 42 being nested in the guiding inclined slot 41. The guiding inclined protrusion 42 is provided on one of the first inclined surface 11 and the second inclined surface 21, and the guiding inclined slot 41 is provided on another one of the first inclined surface 11 and the second inclined surface 21, meaning that their positions can be interchanged on the first inclined surface 11 and the second inclined surface 21. As shown in FIG. 2, according to an embodiment of the present invention, an exemplary embodiment is shown where the guiding inclined protrusion 42 is formed on the main implant body 1, and the guiding inclined slot 41 is formed on the lower block 2.

To ensure that the locking screw 3 does not interfere with mounting of the false tooth, as shown in FIGS. 2 and 3, the top surface of the main implant body 1 is further provided with a storage groove 111 for accommodating an upper end of the locking screw 3; a top surface of the locking screw 3 is arranged to be flush with the top surface of the main implant body 1. In this way, the locking screw 3 can be prevented from protruding out of the top surface of the main implant body 1, thereby avoiding any impact on the mounting of the false tooth and ensuring practicality and reliability.

To further enhance the frictional fixation strength of the present invention during the implantation process and prevent slippage, as shown in FIG. 1, outer surfaces of the main implant body 1 and the lower block 2 are designed to be anti-slippery textured surfaces 6. The design of the anti-slippery textured surface 6 enables the false tooth implanting device to achieve a better fixation effect between the false tooth and the implant hole, increasing the contact friction coefficient and preventing issues such as slippage and loose fixation.

To prevent calcification of the alveolar bone at the implantation site after the false tooth is implanted, as shown in FIGS. 1 and 2, the main implant body 1 and the lower block 2 are further provided with a plurality of transverse micropores 7. In this way, blood blockage can be well prevented, thereby preventing bone calcification due to prolonged lack of blood flow.

To ensure that the false tooth implanting device can be more securely installed in the implant hole of the alveolar bone, as shown in FIG. 1, a diameter of the lower block 2 is the same as a diameter of the main implant body 1. This structural design allows the false tooth implanting device to be directly embedded down to an inner bottom surface of the implant hole in the alveolar bone, thereby increasing the contact area with the implant hole and enhancing the stability of the installation.

In a practical application, as shown in FIG. 3, after the false tooth is secured onto the main implant body 1, a hole on the false tooth for insertion of the vertical securing screw 5 can be completely filled and covered using existing dental filling techniques to prevent the accumulation of dirt and ensure oral cleanliness and health.

What is claimed is:

1. A false tooth implanting device with widening effect, comprising a main implant body (1), a lower block (2), and a vertical screw (3); a first inclined surface (11) and a vertical insertion hole (12) is provided on the main implant body (1); a second inclined surface (21) is provided on the lower block (2); the first inclined surface (11) and the second inclined surface (12) are slidably engaged with each other; a guide structure (4) is provided between the second inclined surface (21) and the first inclined surface (11); the vertical screw (3) passes through the vertical insertion hole (12) of the main implant body (1) and threads into the lower block (2); wherein:
the false tooth implanting device further comprises a vertical securing screw (5) which is smaller than the vertical screw (3); a screw hole (31) is further formed vertically in a middle part of the vertical screw (3); the vertical securing screw (5) is threaded to the screw hole (31);
a top surface of the main implant body (1) is provided with an installation direction indicator (10) to indicate a mutual sliding direction between the main implant body (1) and the lower block (2) and thus a direction of the widening effect of the false tooth implanting device being achieved.

2. The false tooth implanting device of claim 1, wherein the guide structure (4) comprises a guiding inclined slot (41) and a guiding inclined protrusion (42).

3. The false tooth implanting device of claim 1, wherein the top surface of the main implant body (1) is further provided with a storage groove (111) in which an upper end of the locking screw (3) is accommodated; a top surface of the locking screw (3) is flush with the top surface of the main implant body (1).

4. The false tooth implanting device of claim 1, wherein outer surfaces of the main implant body (1) and the lower block (2) are anti-slippery textured surfaces (6).

5. The false tooth implanting device of claim 1, wherein the main implant body (1) and the lower block (2) are further provided with a plurality of transverse micropores (7).

6. The false tooth implanting device of claim 1, wherein a diameter of the lower block (2) is the same as a diameter of the main implant body (1).
